(19) United States
(12) Patent Application Publication
(10) Pub. No.: US 2020/0190779 A1
(43) Pub. Date: Jun. 18, 2020

(54) REMOTE BACK-FLOW DETECTON & SHUT-OFF SYSTEM

(71) Applicant: Elmer Richard Wagner, Gig Harbor, WA (US)

(72) Inventor: Elmer Richard Wagner, Gig Harbor, WA (US)

(21) Appl. No.: 16/221,343

(22) Filed: Dec. 14, 2018

(51) Int. Cl. E03C 1/10; F16K 17/02; F16K 17/36

(52) U.S. Cl. CPC E03C 1/10; E03C 1/106; F16K 17/36; F16K 17/02

(57) ABSTRACT

The two Remote Back-flow Detection and Shut-off Systems that are developed by this patent narrows the possible 12 month time span for contaminating back-flow by detecting and shutting off the back-flow while not changing the current installation or inspection methods of the double check valve assembly.

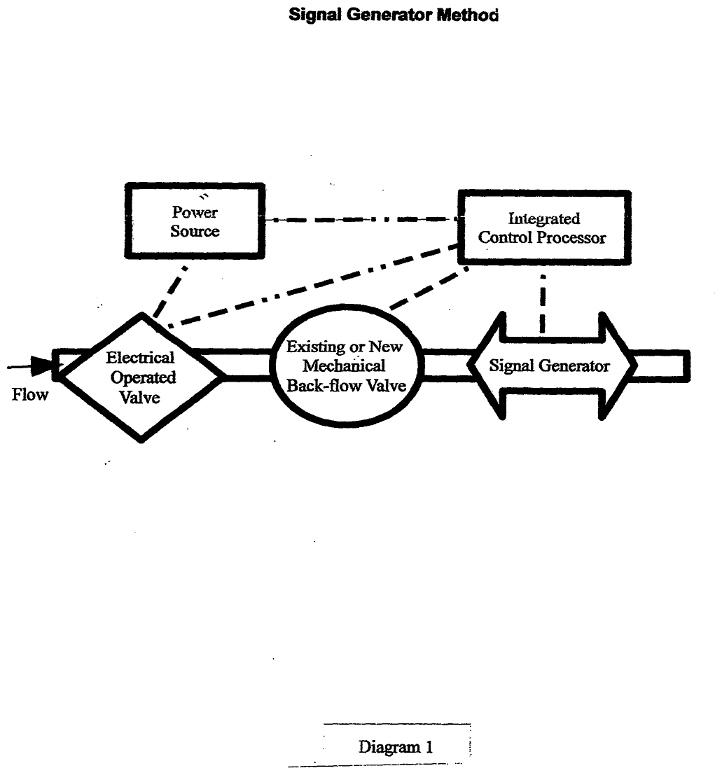

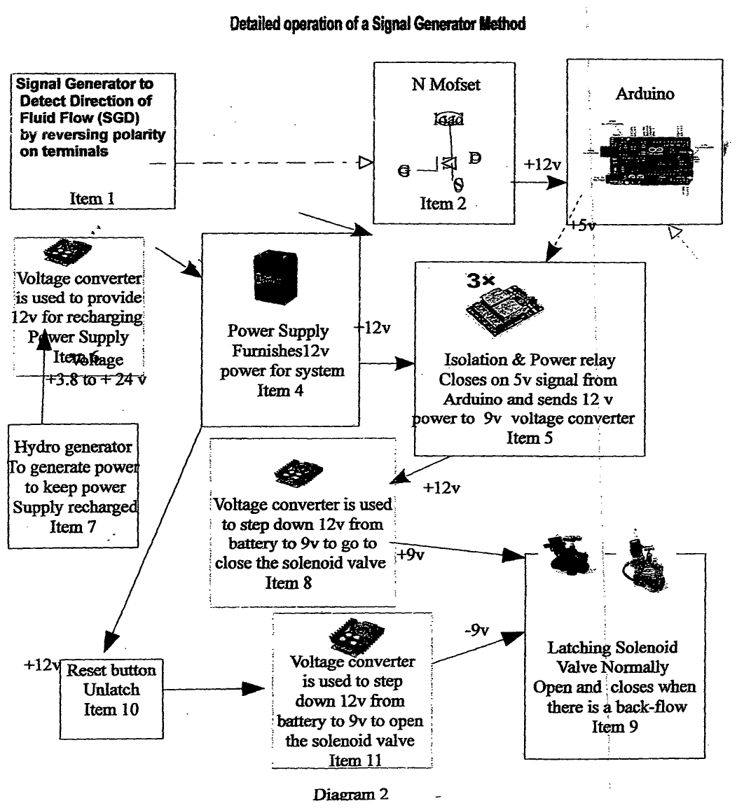

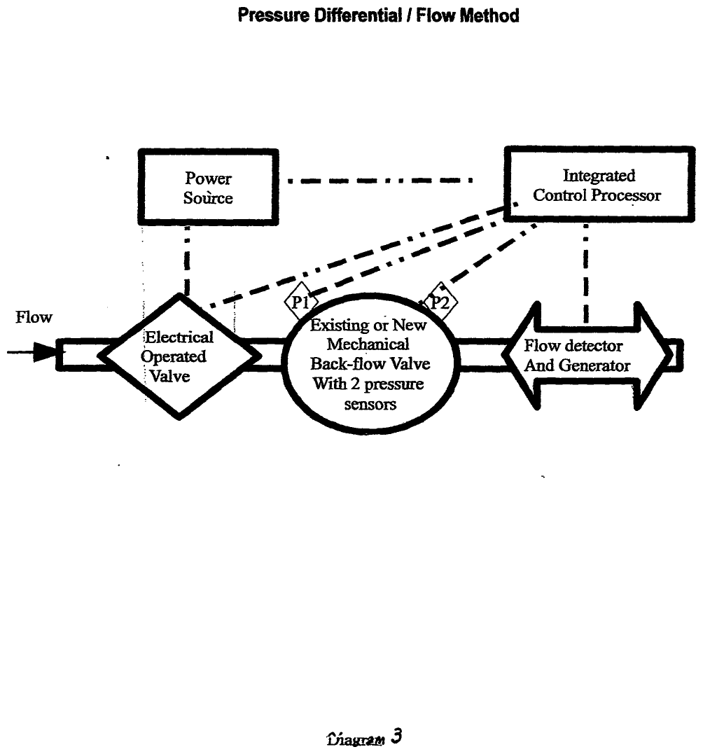

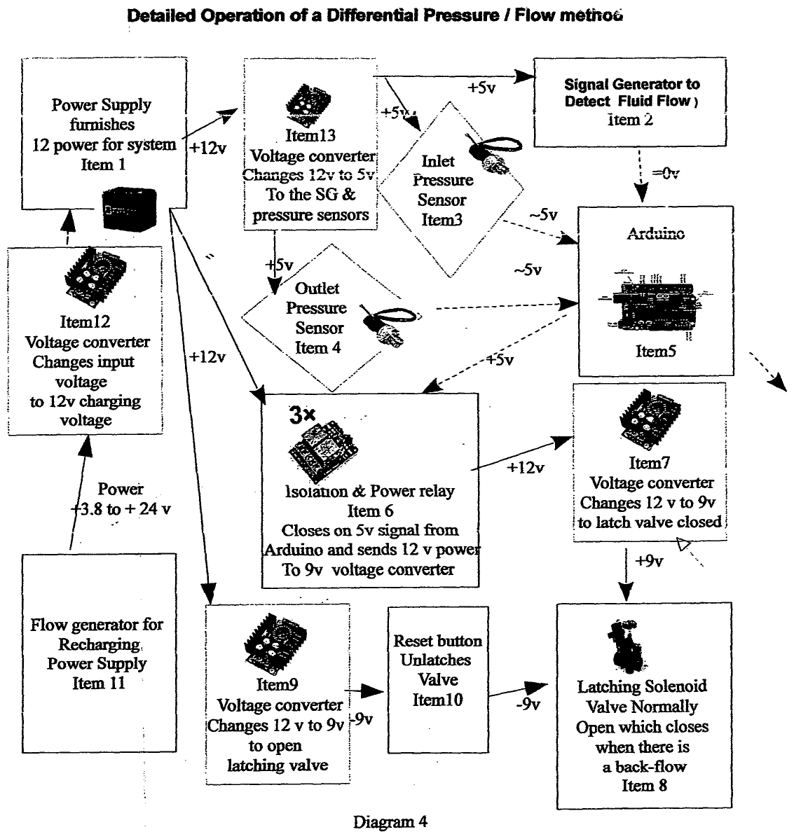

### CROSS-REFERENCES

| | APPLICATION | FILING |
|---|---|---|
| TITLE OF PRVISIONIAL PATENT | NO | DATE |
| SIGNAL GENERATOR TO DETECT | 62/774,316 | Dec. 2, 2018 |
| DIRECTION OF FLUID FLOW | | |
| REMOTE BACK-FLOW SHUT-OFF | 62/709413 | Jan. 19, 2018 |
| SYSTEM | | |

### STATEMENT REGARDING FEDERALLY SPONSORED RESEARCH OR DEVELOPMENT

The Inventor, Elmer R. Wagner, declares the there has been no federally funded research or development.

### THE NAMES OF THE PARTIES TO A JOINT RESEARCH AGREEMENT

The inventor, Elmer R, Wagner. declares that there are no joint research agreements.

### SEQUENCE LISTING

This patent application does not contain any computer programs.

### STATEMENT REGARDING PRIOR DISCLOSURES BY THE INVENTOR OR A JOINT INVENTOR

This invention has the associated Provisional patents:

| | APPLICATION | FILING |
|---|---|---|
| TITLE | NO | DATE |
| SIGNAL GENERATOR TO DETECT | 62/774,316 | Dec. 2, 2018 |
| DIRECTION OF FLUID FLOW | | |
| Remote Back-Flow Shut-off System | # 62/709413 | (Jan. 19, 2018) |

### BACKGROUND OF THE INVENTION

For many years the a double check valve back-flow assembly was regarded as the “best” method available to prevent the cross-contamination of the potable supply water system. The possibility of both check valves of the double check valve back-flow assembly being compromised led to the requirement that the double check valve back-flow assemblies be inspected annually. The annual annual inspection still allowed for possibility that there was an open window of 12 months where cross-contamination might occur. Note: The Washington Department of Health has mandated certain rules regarding the annual inspection of back-flow assemblies. While the systems developed by this patent may have various applications, it was developed by the inventor who could not find a simple commercial method of detecting a back-flow condition and reducing the 12 month time span of possible contamination using existing double check valve back-flow devices.

### BRIEF SUMMARY OF THE INVENTION

The nature and substance of this invention is to develop and implement a safer back-flow detection and shut-down system to protect the fluids (potable water) from contamination.

The Remote Back-Flow Detection & Shut-Off System contains four major areas of development:
1 back-flow prevention
2 back-flow detection
3 remote power source
4 integrated electro-mechanical control.

### BRIEF DESCRIPTION OF THE SEVERAL VIEWS OF THE DRAWINGS/DIAGRAMS

Diagrams 1 and 3 are to show the major components of of the two possible solutions and that all are interrelated. One is for the reverse polarity solution the other is for the pressure/flow solution.

Diagrams 2 and 4 use some elements/components which would be part of sub-assemblies of the present invention are illustrated as an examples and are not limited by the configuration or components that are in the diagrams.

Several prototype assemblies were developed using off-the-shelf items which were provided by wholesale, commercial, and industrial suppliers except for the Signal Generator to Detect Direction of Fluid Flow (SGD). There are possible other commercial and industrial devices which can perform the same functions and are incorporated herein by reference. As an example, there may be more than one latching type electrically operated valve that will perform the same function as the ones shown on the diagrams used in this application. The Signal Generator to Detect Direction of Fluid Flow (SGD) was developed and built by the inventor and it has a provisional patent at this time.

Some elements of the present invention on diagrams 2 and 4 are illustrated as an example and are not limited by the figures on the accompanying diagrams.

Prototype units of the systems were developed using off-the-shelf items which were provided by wholesale, commercial, and industrial suppliers except for the Signal Generator to Detect Direction of Fluid Flow (SGD). The Signal Generator to Detect Direction of Fluid Flow (SGD was developed and built by the inventor and it has a patent pending.

There are possible other commercial and industrial devices which can perform the same functions and are incorporated herein by reference. i.e. There may be more than one latching type electrically operated valve that will perform the same function as the one used in this application.

### DETAILED DESCRIPTION OF THE INVENTION

The REMOTE BACK-FLOW DETECTION & SHUT-OFF SYSTEM refers to the technical field of the potable water supply back-flow protection. The invention is to be installed at the water connection of a potable water user after the meter, and provides the necessary means for detecting and stopping a back-flow condition.

While reviewing the double check back-flow device used in back-flow protection and the need for annual inspection of the device with a water company representative, the inventor mentally noted that the current system had an open window of time where back-flow could occur. The current patent was derived from this discovery.

Back-flow can occur as the water pressure on the user side of the double check valve back-flow device and water pressure on the service side of the double check valve oscillate with demand. The double check valve assembly mechanically closes if the user side pressure is greater than the service side. However it was discovered that older double check valve back-flow valve assembles and similar mechanical devices could be compromised because of debris build-up or aging. This possible compromise of the check valves caused the mandated need for annual inspections of double check valve back-flow devices. Unfortunately the annual inspection of double check valve back-flow devices and similar mechanical devices produces a time span of up to 12 months where the possibility of back-flow contamination can occur.

As a result of this discovery, the inventor who has extensive engineering background in mechanical and electro-mechanical design systems, designed the following REMOTE BACK-FLOW DETECTION & SHUT-OFF SYSTEM

With reference now to the drawings, and in particular to Diagrams 1 and 3, thereof, a REMOTE BACK-FLOW DETECTION & SHUT-OFF SYSTEM embodies the principles and consists of 5 major subsystems as follows:
1) Existing or new Mechanical Back-Flow Valve (MBFV) valve with pressure sensors (as needed).

NOTE: The mechanical double check back-flow valve under normal operating conditions serves to isolate the user side from the supplier side by mechanically closing down as the demand by the user decreases. If this valve is compromised by corrosion, debris, etc. a back-flow condition can happen.
2) Back-flow Sensor and Power Generator (BFSG)
The BFSG generates electrical energy which is used to supply recharge energy and generates an electrical signal which will turn on the ICP when a back-flow is detected.
3) Power Storage (PS)
The PS will receive the generated system power from the generator and stores it for use as needed by the system.
4) Integrated Control Processor Assembly (ICP)
The ICP receives signals and electrical power data from the other components and performs the necessary programmed functions as determined by the program logic.
5) Motor Operated or LATCHING Solenoid Valve (MOSV)
The function of the MOSV is to isolate the user side from the supplier side and is operated by the ICP when a back-flow condition occurs.

The detection of a back-flow conditions has two viable solutions.
1) Detection by Electro-mechanical flow direction assembly which detects direction by reverse polarity on the terminals.
2) Detection is by sensing the pressure at the meter lower than the pressure at the outlet of the double check valve assembly with simultaneously occurring flow.

With reference now to the drawings, and in particular to Diagrams 2 and 4, thereof, some elements of the present invention are illustrated as an examples and are not limited by the figures in the diagrams. Models units which replicated the actions of the sub-systems were developed using off-the-shelf items which were provided by wholesale, commercial, and industrial suppliers except for the Signal Generator to Detect Direction of Fluid Flow. There are possible other configurations and commercial and industrial devices which can perform the same functions and are incorporated herein by reference. i.e. There may be more than one latching type electrically operated valve that will perform the same function as the ones shown on the diagrams used in these applications. The Signal Generator which is used to Detect Direction of Fluid Flow was developed and built by the inventor and it has a provisional patent.

Diagrams 2 which is designated as Signal Generator Method, there are eleven suggested components in this particular configuration which are as follows:

Diagram 2 Components

| Component | | Component | Component |
|---|---|---|---|
| Item number | Component Function | Designation | Description |
| 1 | Generate Back-flow signal information | BFSG | Flow detector |
| 2 | Electronic Switch | N Mosfet | electronic switch |
| 3 | Electronic computer controller | Ardreno | Programmable |
| | | | controller |
| 4 | Furnish remote electrical power for | Power Supply | Battery |
| | the system | | |
| 5 | Realign power voltage to match that of | Isolation & Power | Relay |
| | voltage converter | Relay | |
| 6 | Voltage converter variable voltage to | Voltage converter | Buck-boost |
| | 12 v for recharging battery | | |
| 7 | generate variable voltage | Hydro Generator | Hydro-Generator |
| 8 | convert 12 v from power supply to 9 v | Voltage converter | Buck-boost |
| | for Latching Solenoid | | |
| 9 | Shut -off flow and isolate water after | Latching Solenoid | Latching Solenoid |
| | the meter | Valve | Valve |
| 10 | provide method to reestablish normal | Reset Button | Push Button |
| | flow | | |
| 11 | convert 12 v from battery to 9 volts | Voltage converter | Buck-boost |

Diagram 4 which is designated as Differential Pressure/Flow Method has thirteen suggested components which are as follows:

Diaqram 4 Component designation and function

| Component Item | | Component | Component |
|---|---|---|---|
| number | Component Function | Designation | Description |
| 1 | Furnish remote electrical | Remote Power | Battery |
| | power for the system | Supply | |
| 2 | Generate Back-flow signal | Signal Generator | Flow detector |
| | information | | |
| 3 | Furnish voltage signal to | Inlet Pressure | Pressure |
| | Arduino from inlet | Sensor | transducer |
| 4 | Furnish voltage signal to | Outlet Pressure | Pressure |
| | Arduino from outlet | Sensor | transducer |
| 5 | receive, process and send | Arduino | Micro processor |
| | electrical date | | board |
| 6 | Send 12 power to voltage | Isolation & Power | Relay |
| | converter | Relay | |
| 7 | Supply 9 v to Latching | Voltage converter | Buck-boost |
| | Solenoid | | |
| 8 | Latch close & latch open | Latching Solenoid | Latching |
| | water supply | Valve | Solenoid Valve |
| 9 | Supply 9 v to Latching | Voltage converter | Buck-boost |
| | Solenoid | | |
| 10 | Send 12 power to voltage | Reset Button | Push Button |
| | converter | | |
| 11 | Generate recharging | Flow Generator | hydro generator |
| | voltage | | |
| 12 | Convert incoming voltage to | Voltage converter | Buck-boost |
| | 12 vdc | | |
| 13 | Convert incoming voltage to | Voltage converter | Buck-boost |
| | 5 vdc | | |

The Integrated Control Processor Assembly uses standard off-the-shelf components such as an Arduino micro-controller and standard computer languages such as “C”. Related standard commands will compare the pressures and other necessary electronic data to assemble a program which will integrate the control system, i.e., pressure at outlet is greater than pressure at inlet and flow is greater than zero.

1. A Remote Back-Flow Detection and Shut-off System is a system for detecting a back-flow condition and shutting the flow off at the outlet side of the service meter. The Detection of a back-flow conditions has two viable solutions.
1) Detection by Electro-mechanical flow direction assembly which detects direction by reverse polarity on the terminals.
2) Detection is by sensing the Pressure at the meter lower than the pressure outlet of the double check valve assembly with simultaneously occurring flow.

2. The basic elements comprising a Remote Back-Flow Detection and Shut-off System of using an Electro-mechanical flow direction assembly noted in claim 2, are:
1) Signal Generator to Detect Direction of Fluid Flow (SGD)
2) Micro-controller and other control devices (relays, etc)
3) A power source
4) A latching shut-off valve
5) A double check valve back-flow assembly-

3. The basic elements comprising a Remote Back-Flow Detection and Shut-off System of using an two pressure sensors and an electro-mechanical device to provide a signal detected by the flow of the fluid are:
1) Signal Generator to Detect of Fluid Flow (SGD)
2) Micro-controller and other control devices (relays, etc)
3) A power source
4) A latching shut-off valve
5) A double check valve back-flow assembly
6) Two pressure sensors.
